(19) United States
(12) Patent Application Publication
(10) Pub. No.: US 2019/0104580 A1
(43) Pub. Date: Apr. 4, 2019

(54) INTEGRALLY PACKAGED LIGHT-EMITTINGDEVICE AND DRIVING METHOD THEREOF

(71) Applicant: GUAN-JIE LUO, Taipei (TW)

(72) Inventors: Guan-Jie Luo, Taipei (TW); Shao-Wei Chiu, Taipei (TW)

(21) Appl. No.: 16/147,584

(22) Filed: Sep. 29, 2018

(30) Foreign Application Priority Data
Sep. 29, 2017 (TW) 106133712

(51) Int. Cl. H05B 33/08; H05B 37/02

(52) U.S. Cl. CPC H05B 33/0809; H05B 33/0845; H05B 37/0272

(57) ABSTRACT

The invention provides an integrally packaged lighting device comprising: a package body, a plurality of light-emitting diode units, a rectifier unit, a linear constant current unit, and a wireless dimming unit. The light-emitting diode units are set in the package body. The rectifier unit is used for providing power to the light-emitting diode units. The linear constant current unit electrically connects with a common node of the light-emitting diode units for controlling each of the light-emitting diode units. The wireless dimming unit is used for wirelessly controlling the linear constant current unit. At least part of the light-emitting device unit, at least part of the rectifier unit, at least part of the linear constant current unit, and at least part of the wireless dimming unit are embedded in the material of the package body.

### CROSS REFERENCE

THE PRESENT INVENTION CLAIMS PRIORITY TO TW106133712, FILED ON Sep. 29, 2017.

### BACKGROUND OF THE INVENTION

### Field of Invention

The present invention relates to a lighting device and driving method thereof. Especially, the present invention relates to an integrally packaged light-emitting device and driving method thereof with an embedded driving circuit which is integrally packaged with a light-emitting diode.

### Description of Related Art

Traditionally, a lighting device comprises a light-emitting device, a driving circuit, and a shell. The light-emitting device is packaged with prior packaging technology. The driving circuit is set in a space between the light-emitting device and the shell and used for controlling the lighting performance of the light-emitting device. The prior light-emitting device and the prior driving circuit are usually set separately and difficult to package integrally. In addition, a heat dissipation plate is usually set on the light-emitting device for reducing a large amount of heat generated from the light-emitting device. The prior driving circuit and heat dissipation plate always occupied a pre-determined space, so that the volume of the prior lighting device cannot be effectively reduced.

### SUMMARY OF THE INVENTION

To the technical problems above-mentioned, the objects of the present invention are to provide an integrally packaged lighting device and driving method thereof, wherein an embedded driving circuit is integrally packaged with light-emitting diode (LED) units together.

In one perspective, the present invention provides an integrally packaged lighting device comprising: a package body; a plurality of light-emitting diode units set in the package body; a rectifier unit for providing power to the light-emitting diode units; a linear constant current unit electrically connecting with a common node of the light-emitting diode units for controlling each of the light-emitting diode units; and a wireless dimming unit for wirelessly controlling the linear constant current unit; wherein at least part of the light-emitting device unit, at least part of the rectifier unit, at least part of the linear constant current unit, and at least part of the wireless dimming unit are embedded in the material of the package body.

In another perspective, the present invention provides a driving method for the integrally packaged lighting device, wherein the integrally packaged lighting device comprises the plurality of light-emitting diode units, the rectifier unit, and the linear constant current unit and the wireless dimming unit. The driving method comprises: coupling the wireless dimming unit to the linear constant current unit; controlling the on-time or the amount of current of the linear constant current unit by the wireless dimming unit through a linear level dimming signal or a Pulse Width Modulation (PWM) signal; and controlling the light-emitting diode units to emit light according to a signal from the linear constant current unit based on the linear level dimming signal or a Pulse Width Modulation (PWM) signal.

In one embodiment, the light-emitting device unit, the rectifier unit, the linear constant current unit, and the wireless dimming unit are implemented by a semiconductor manufacturing process, and are embedded by a compression molding technology, a liquid encapsulation technology, an injection molding technology, or a transfer molding technology.

In one embodiment, the present invention further comprises a buck-boost controlling unit electrically connects with the rectifier unit and a node of the linear constant current unit in parallel. The buck-boost controlling unit is used for adjusting a driving voltage of the rectifier unit according by receiving a feed back voltage value from the light-emitting diode units.

In order to better understand the above and other aspects of the present invention, the detailed description of the embodiments and the accompanying drawings are provided as follows.

### BRIEF DESCRIPTION OF THE DRAWINGS

FIG. 1 shows a perspective view of an integrally packaged lighting device 100 according to one embodiment of the present invention.

FIG. 2 shows an electrically connecting diagram of a light-emitting package shell 110 and a power connector 130, according to the integrally packaged lighting device 100 of FIG. 1 of the present invention.

FIG. 3 shows an electrically connecting diagram of a plurality of electric components embedded in the physical material of the light-emitting package shell 110 of FIG. 2, according to the integrally packaged lighting device 100 FIG. 1 of the present invention.

FIG. 4 shows a driving circuit block diagram of the integrally packaged lighting device 100, according to one embodiment of the present invention.

FIG. 5 shows a driving circuit block diagram of the integrally packaged lighting device 100, according to another embodiment of of the present invention.

### DESCRIPTION OF THE PREFERRED EMBODIMENTS

The objectives, technical details, features, and effects of the present invention will be better understood with regard to the detailed description of the embodiments below, with reference to the drawings.

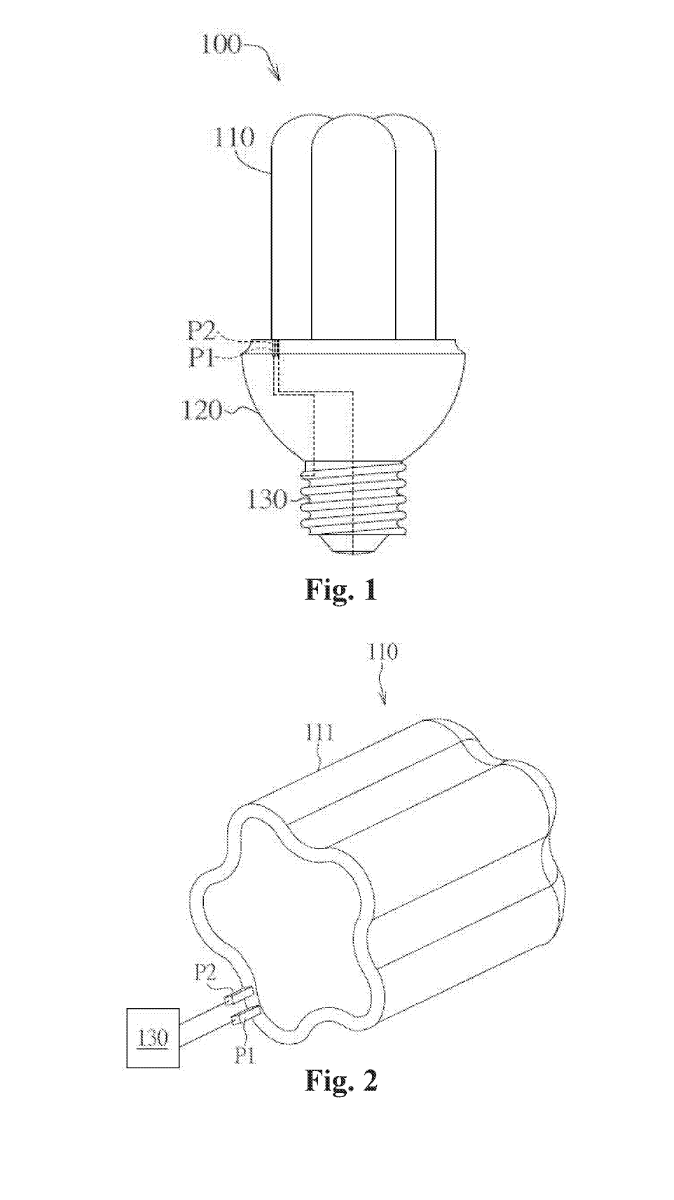

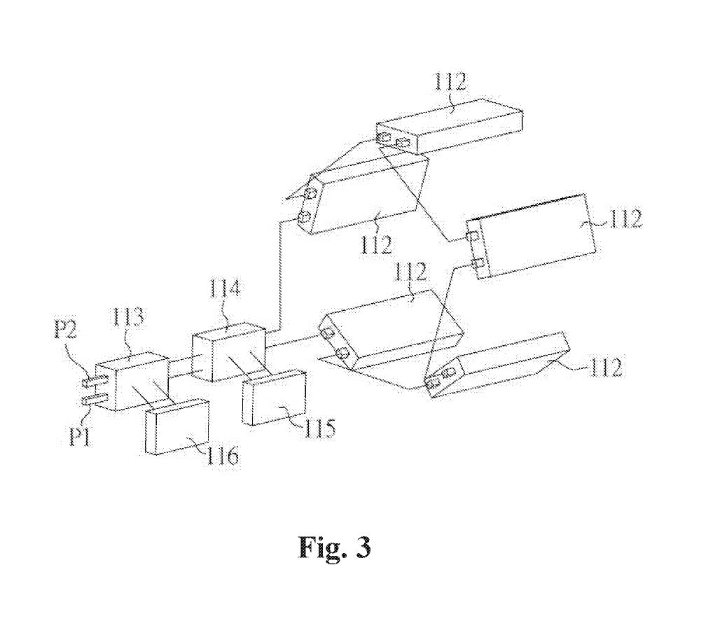

Please refer to FIGS. 1-3, FIG. 1 shows a perspective view of an integrally packaged lighting device 100 according to one embodiment of the present invention. FIG. 2 shows an electrically connecting diagram of a light-emitting package shell 110 and a power connector 130, according to the integrally packaged lighting device 100 of FIG. 1 of the present invention, and FIG. 3 shows an electrically connecting diagram of a plurality of electric components embedded in the physical material of the light-emitting package shell 110 of FIG. 2, according to the integrally packaged lighting device 100 FIG. 1 of the present invention.

As shown in FIGS. 1-2, the integrally packaged lighting device 100 comprises a light-emitting package shell 110, a lamp holder 120 and a power connector 130. The light emitting package shell 110 can be connected to the lamp holder 120 by means of clamping, soldering, etc. As shown in FIG. 1, the power connector 130 can electrically connect with the lamp holder 120. In another embodiment, the lamp holder 120 can be omitted. In this embodiment, the light emitting package shell 110 can be electrically coupled to the power connector 130 directly. As shown in FIG. 2, the light emitting package shell 110 electrically connects with the power connector 130, and then electrically connects with external power supply (not shown).

Please keep refer to FIG. 2, the light-emitting package shell 110 comprises a package body ill, a first electrode P1 and a second electrode P2, wherein the first electrode P1 and the second electrode P2 are exposed from one end surface of the package body 111, and wherein the first electrode P1 and the second electrode P2 can electrically connect with the two electrodes of the power connector 130. The first electrode P1 and the second electrode P2 exposed from the package body 111 can directly connect with the power connector 130 without any driving circuit or other electric components therebetween. That is, there is no driving circuit or other electric components or additional driving components located or electrically connects between the first electrode P1 and the second electrode P2 and the power connector 130. Therefore, the entire volume of the integrally packaged lighting device 100 can be reduced very much.

Please refer to FIG. 3, the light-emitting package shell 110 comprises the package body 111 (shown in FIG. 2), a plurality of light-emitting device unit 112, a rectifier unit 113, a linear constant current unit 114, a wireless dimming unit 115, the first electrode P1 and the second electrode P2 (shown in FIG. 21. The rectifier unit 113 is used for converting AC (Alternating Current) power to DC (Direct Current) power. The wireless dimming unit 115 is used for wirelessly controlling linear constant current unit 114. The light-emitting device unit 112, the rectifier unit 113, the linear constant current unit 114, and the wireless dimming unit 115 can be a circuit implemented by a semiconductor manufacturing process. In other words, all of the above-mentioned circuits are integrally packaged together, wherein the packaging method includes semiconductor manufacturing processes, stamping processes, or punched package manufacturing processes, etc. In another embodiment, any two of the rectifier unit 113, the linear constant current unit 114, and the wireless dimming unit 115 can also be integrated into the same unit. In addition, the light emitting package shell 110 can further include an energy receiver 116 that can wirelessly couple with an external power supply (not shown) to generate a coupling current to provide power to the rectifier unit 113. In this design, the integrally packaged lighting device 100 can be formed without the power connector 130, so that the power connector 130 is omitted. The above-mentioned energy receiver 116 can be implemented by a resonator.

In one embodiment, a packaging technology can be used to make at least part of the light-emitting device unit 112, at least part of the rectifier unit 113, at least part of the linear constant current unit 114, at least part of the wireless dimming unit 115, and at least part of the energy receiver 116 embedded in the physical material of the package body 111 of the light-emitting package shell 110, so that the above-mentioned components can be in close contact with the package body 111 to reduce thermal resistance and improve heat dissipation efficiency. Furthermore, other prior driving circuit can also be embedded in the package body 111 and packaged with the package body 111 together. The connecting lines between the light-emitting device unit 112, the rectifier unit 113, the linear constant current unit 114, the wireless dimming unit 115, or the energy receiver 116 can be connected before being packaged, or after the packaging process, using printing technology. As shown in FIG. 2, the whole outer surface of the package body 111 can perform to be a heat dissipation surface. Therefore, the heat generated from the light-emitting device unit 112, the rectifier unit 113, the linear constant current unit 114, the wireless dimming unit 115, or the energy receiver 116 can be convected into the environment through the large outer surface area of the package body 111 to accelerate the heat dissipation of the lighting device 100. In this design, even though the lighting device 100 is set horizontally (comparing with the lighting device 100 set vertically, as shown in FIG. 1), since the present lighting device 100 has high heat dissipation efficiency, the thermal runway problem will not happen and be eliminated. The above-mentioned packaging technology can be, for example, a compression molding technology, a liquid encapsulation technology, an injection molding technology, or a transfer molding technology.

Furthermore, the package body 111 is preferred a light transmission shell or a transparent shell, so that the light emitted by the light-emitting diode units 112 can pass through the package body 111 to outside. In addition, the package body 111 comprises a fluorescent material for transforming the light wavelength of the light-emitting diode units 112. The package body 111 further comprises a molding material (or a solidifying material) and nano thermal conduction material. The molding material (or the solidifying material) can be an Epoxy material, a Bisphenol A Epoxy material, a Cycloaliphatic-Epoxy material, a Siloxane modified Epoxy Resin material, an Acrylic modified Epoxy Resin, an Organic modified Epoxy Resin material, a Silicone material, a Silicone Gel material, a Silicone Rubber material, a Silicone Resin material, an Organic modified Silicone Resin, a Sapphire glass or glass filler, or a combination of the aforementioned materials in this embodiment.

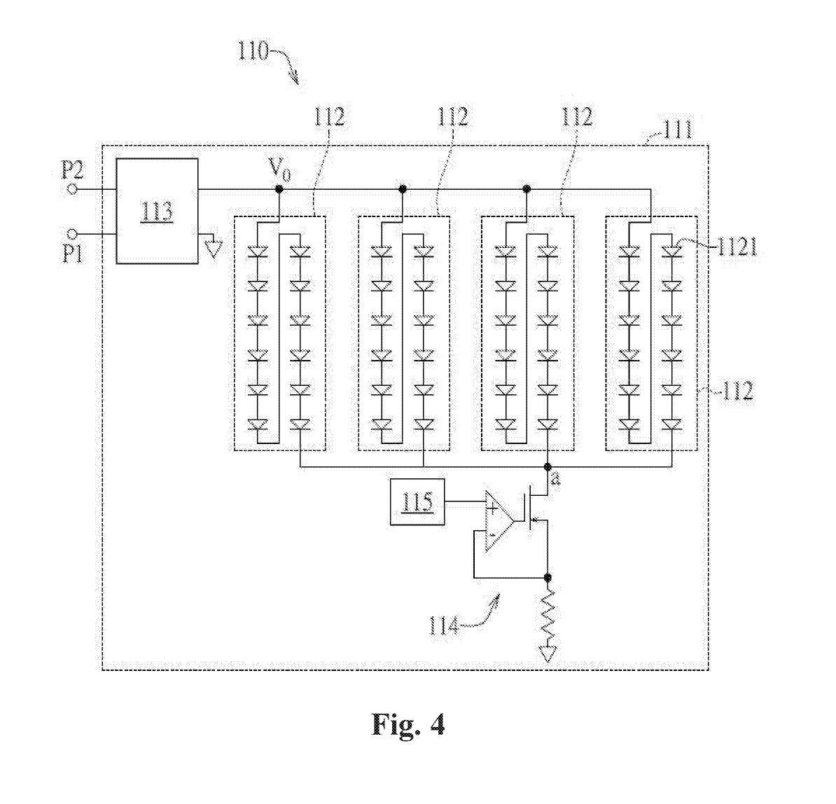

Please keep referring to FIG. 3, the light-emitting diode units 112 may be connected in series, or may be connected in parallel, or may be connected in both series and parallel. The light-emitting diode units 112 can be a packaged lighting unit, which includes a fluorescent material for transforming the light wavelength of a light-emitting device 1121 in the light-emitting diode units 112, as shown in FIG. 4. Each of the light-emitting device unit 112 includes a plurality of light-emitting devices 1121 connected with each other in series. In another embodiment, the plurality of light-emitting devices 1121 of the light-emitting device unit 112 may be connected in parallel, or may be connected in both series and parallel.

According to the embodiment of the present invention, the connection relationship between the light-emitting device unit 112, the rectifier unit 113, the linear constant current unit 114 and the wireless dimming unit 115, is not limited by FIG. 3. The following are examples of other electrical connections.

Please refer to FIG. 4, it shows a driving circuit block diagram of the light-emitting package shell 110, according to one embodiment of the present invention. The light-emitting package shell 110 comprises the package body 111, the plurality of light-emitting diode units 112, the rectifier unit 113, at lease one linear constant current unit 114, the wireless dimming unit 115, the first electrode P1, and the second electrode P2.

As shown in FIG. 4, the rectifier unit 113 is electrically coupled to the plurality of light-emitting diode units 112 for providing electric power to the plurality of light-emitting diode units 112 from external power supply through the first electrode P1 and the second electrode P2. In this embodiment, the light-emitting diode units 112 electrically connect with the linear constant current unit 114. For example, the light-emitting diode units 112 electrically connect at a common node a (shown in FIG. 4), and the linear constant current unit 114 also electrically connects with the node a (source or drain). The wireless dimming unit 115 is electrically coupled to the linear constant current unit 114 for controlling the on-time (i.e. the amount of current) of the linear constant current unit 114 by using a linear level dimming signal or a Pulse Width Modulation (PWM) signal. Therefore, the illumination performance of the light-emitting device unit 112, such as light intensity or color temperature, can be further controlled by the linear constant current unit 114. In addition, an external controlling apparatus (not shown) can also be used to control the wireless dimming unit 115. For example, the external controlling apparatus can be a mobile phone, a computer, or other electric apparatus, etc.

In one embodiment, the present rectifier unit 113 can be a Bridge rectifier. After a full-wave being rectified into a DC sine wave waveform, the light-emitting device unit 112 is then driven.

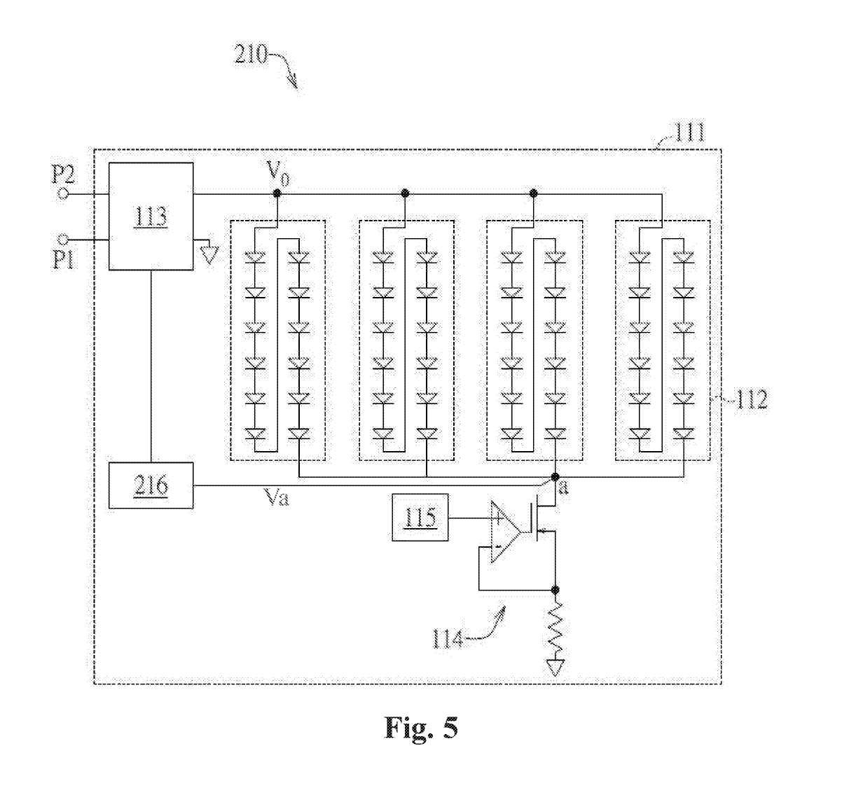

Please refer to FIG. 5, it shows a driving circuit block diagram of the light-emitting package shell 210, according to another embodiment of the present invention. The light-emitting package shell 210 comprises the package body 111, the plurality of light-emitting diode units 112, the rectifier unit 113, at lease one linear constant current unit 114, the wireless dimming unit 115, a buck-boost controlling unit 216, the first electrode P1, and the second electrode P2. The difference between the light-emitting package shell 110 of FIG. 4 and the light-emitting package shell 210 of FIG. 5 is that the light-emitting package shell 210 of FIG. 5 has the buck-boost controlling unit 216, and the light emitting package shell 210 can feed back the voltage value Va of the node a to the buck-boost controlling unit 216 to adjust the driving voltage V₀ of the rectifier unit 113. The buck-boost controlling unit 216 can be implemented by a semiconductor manufacturing process.

As shown in FIG. 5, the buck-boost controlling unit 216, the rectifier unit 113, and the linear constant current unit 114 are electrically connected with each other at node a in parallel, and the buck-boost controlling unit 216 are electrically coupled to the rectifier unit 113. The buck-boost controlling unit 216 can adjust the driving voltage V₀ of the rectifier unit 113 according to the voltage value Va at the node a. As the above-mentioned feed back design, the buck-boost controlling unit 216 can adjust the driving voltage V₀ of the rectifier unit 113 according to the actual characteristics of the light-emitting device unit 112, thereby reducing the loss rate of the integrally packaged lighting device 100.

In the following equation (1), V_{LED} represents the driving voltage of the light-emitting device unit 112, and V_{ref} represents a reference voltage value of an error amplifier (not shown) in the rectifier unit 113. When the feedback control is in a steady state, the voltage value Va of the node a is substantially equal to the reference voltage value V_{ref}, and the driving voltage V₀ at this time is substantially equal to the sum of the driving voltage V_{LED} of the light-emitting device unit 112 and the reference voltage value V_{ref}.

V₀=V_{LED}+V_{ref} (1)

In one embodiment, the location of the linear constant current unit 114 is not limited at the common input end node of the light-emitting diode units 112. The location of the linear constant current unit 114 can be even at the common output end node of the light-emitting diode units 112.

In summary, as mentioned above, the present lighting device comprises only the light-emitting package shell and the power connector. The driving circuit and the light-emitting diode units (and other electric components) are embedded in the light-emitting package shell, so that the light-emitting package shell can electrically connect with the power connector directly without through external driving circuit, thereby reducing the volume of the present integrally packaged light-emitting device. Furthermore, the light emitting package shell further includes the energy receiver to wirelessly couple with an external power supply to provide power to the rectifier unit. Therefore, the power connector can be omitted, so that the volume of the present integrally packaged light-emitting device can be further reduced.

In one embodiment, since the light-emitting diode units and the driving circuit are integrally packaged together, each light-emitting device unit can be controlled respectively by the driving circuit, so that the lighting performance can be improved and more stably.

In one embodiment, the light-emitting package shell comprises the light-emitting diode units. At least part of each light-emitting device unit can be packaged and embedded in the package body of the light-emitting package shell 110. The heat generated by the light-emitting diode units can be dissipated by the large surface area provided is convected to the external environment to improve the heat dissipation efficiency of the lighting device.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention.

What is claimed is:

1. An integrally packaged lighting device comprising:
a package body;
a plurality of light-emitting diode units set in the package body;
a rectifier unit for providing power to the light-emitting diode units;
a linear constant current unit electrically connecting with a common node of the light-emitting diode units for controlling each of the light-emitting diode units; and
a wireless dimming unit for wirelessly controlling the linear constant current unit;
wherein at least part of the light-emitting device unit, at least part of the rectifier unit, at least part of the linear constant current unit, and at least part of the wireless dimming unit are embedded in the material of the package body.

2. The integrally packaged lighting device of claim 1, wherein the package body is a light transmission shell or a transparent shell.

3. The integrally packaged lighting device of claim 1, wherein the light-emitting device unit, the rectifier unit, the linear constant current unit, and the wireless dimming unit are implemented by a semiconductor manufacturing process, and are embedded by a compression molding technology, a liquid encapsulation technology, an injection molding technology, or a transfer molding technology.

4. The integrally packaged lighting device of claim 1, wherein the light-emitting diode units are connected in series, in parallel, or in both series and parallel.

5. The integrally packaged lighting device of claim 1, all of the light-emitting diode units are coupled to the linear constant current unit.

6. The integrally packaged lighting device of claim 1, further comprising an energy receiver for wirelessly coupling with an external power supply to generate a coupling current to provide power to the rectifier unit.

7. The integrally packaged lighting device of claim 1, further comprising a buck-boost controlling unit, which is embedded or partly embedded in the material of the package body for receiving a feed back voltage value from the light-emitting diode units to adjust a driving voltage of the rectifier unit.

8. The integrally packaged lighting device of claim 1, further comprising a first electrode and a second electrode, which are exposed from the package body, and electrically connect with the rectifier unit.

9. The integrally packaged lighting device of claim 1, further comprising a power connector for directly connecting with the rectifier unit.

10. A driving method for the integrally packaged lighting device of claim 1, wherein the integrally packaged lighting device comprises the plurality of light-emitting diode units, the rectifier unit, and the linear constant current unit and the wireless dimming unit, the driving method comprising:
coupling the wireless dimming unit to the linear constant current unit;
controlling the on-time or the amount of current of the linear constant current unit by the wireless dimming unit through a linear level dimming signal or a Pulse Width Modulation (PWM) signal; and
controlling the light-emitting diode units to emit light according to a signal from the linear constant current unit based on the linear level dimming signal or a Pulse Width Modulation (PWM) signal.

11. The driving method of claim 10, further comprising a buck-boost controlling unit, which electrically connects with the rectifier unit and a node of the linear constant current unit in parallel, wherein the buck-boost controlling unit is used for adjusting a driving voltage of the rectifier unit according to a voltage value at the node of the linear constant current unit.
